(19) United States
(12) Patent Application Publication
(10) Pub. No.: US 2011/0056083 A1
(43) Pub. Date: Mar. 10, 2011

(54) Degradable string for string trimmer

(76) Inventor: Tsan-Ching Wang, Homei (TW)

(21) Appl. No.: 12/585,160

(22) Filed: Sep. 8, 2009

(51) Int. Cl. A01D 34/52

(52) U.S. Cl. 30/345; 30/346

(57) ABSTRACT

A string for string trimmer has a non-circular cross section and is made of degradable material such as Polylactide (PLA), Polycaprolactone (PCL) or Polyvinyl Acetate (PVA). The string is a spiral string with multiple cutting edges spirally extending along a longitudinal axis of the string.

### FIELD OF THE INVENTION

The present invention relates to a string for string trimmer, and more particularly, to a degradable string for string trimmer, and the string has spiral cutting edges to improve trimming efficiency.

### BACKGROUND OF THE INVENTION

A conventional string for string trimmer generally is made of plastic material and includes circular cross section which is easily manufactured for the manufacturers. However, the conventional string has smooth outer surface which does not have satisfied trimming function so that the speed that the string is driven has to be high enough to cut the weeds. Besides, during trimming the weeds, the strings are worn and the debris spreads among the weeds and mixed with the soil. The plastic material of the debris cannot be degradable and contaminates the soil. Furthermore, the air resistance for the conventional strings is another concern for the manufacturers.

The present invention intends to provide a string for string trimmer and the string is made of degradable materials and includes spiral cutting edges to improve the shortcomings of the conventional strings.

### SUMMARY OF THE INVENTION

The present invention relates to a string for string trimmer has a non-circular cross section and is made of degradable material such as Polylactide (PLA), Polycaprolactone (PCL) or Polyvinyl Acetate (PVA). The string is a spiral string with multiple cutting edges spirally extending along a longitudinal axis of the string.

The primary object of the present invention is to provide a string which is friendly to the environment and has improved trimming or cutting ability.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a section of the string of the present invention and shows the cross section of the string;

FIG. 2 shows the cross section of a second embodiment of the string of the present invention;

FIG. 3 shows the cross section of a third embodiment of the string of the present invention, and

FIG. 4 shows the cross section of a fourth embodiment of the string of the present invention.

### DETAILED DESCRIPTION OF THE PREFERRED EMBODIMENT

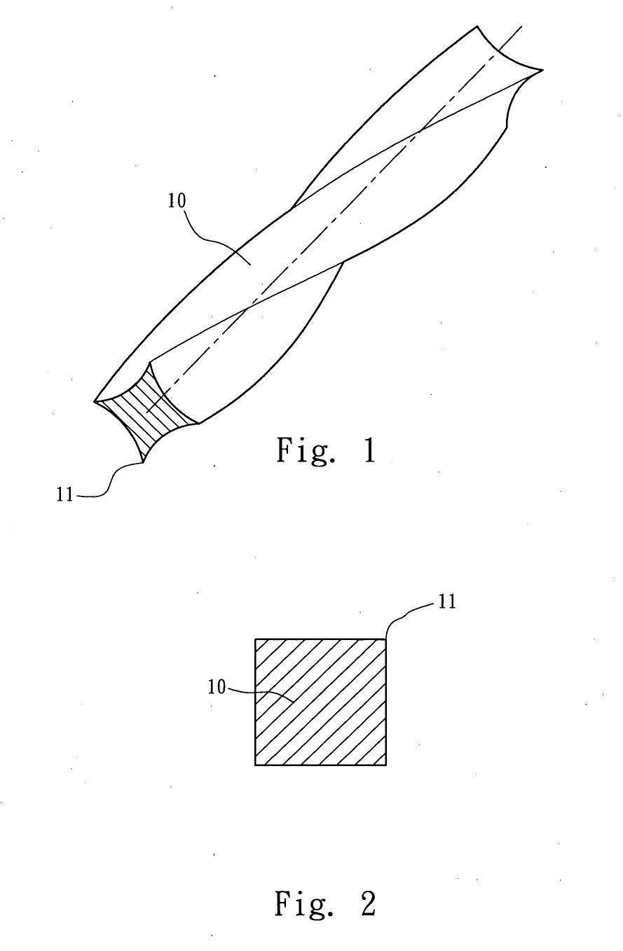

Referring to FIG. 1, the string 10 for string trimmer of the present invention is a string with a non-circular cross section and made of degradable material such as Polylactide (PLA), Polycaprolactone (PCL) and Polyvinyl Acetate (PVA). The string 10 is a spiral string with multiple cutting edges 11 spirally extending along a longitudinal axis of the string. The spiral string allows the air to quickly flow along the grooves between the cutting edges 11 so that the resistance is minimized. The multiple cutting edges 11 efficiently cut or trim the weeds to improve its efficiency.

The material that is used to make the string 10 is degradable so that the debris of the string 10 or even the broken segments of the string 10 can be degradable and does not contaminate the soil.

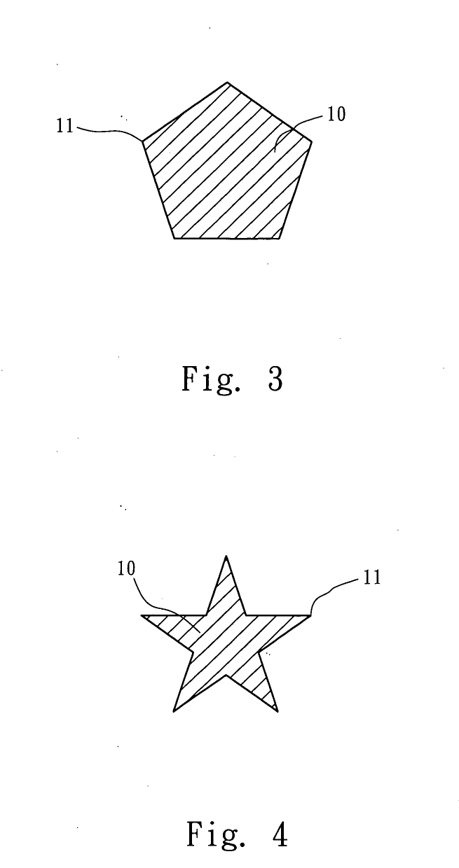

The string 10 may have different shapes of cross section such as the rectangular cross section shown in FIG. 2, the hexagonal cross section shown in FIG. 3 and the star-shaped cross section shown in FIG. 4.

The string 10 of the present invention can be degraded in soil and includes multiple cutting edges 11 which cut or trim the weeds more efficient than the conventional strings. The grooves between the cutting edges 11 provide paths for the air flowing therethrough so that the resistance from air can be minimized.

While we have shown and described the embodiment in accordance with the present invention, it should be clear to those skilled in the art that further embodiments may be made without departing from the scope of the present invention.

What is claimed is:

1. A string for string trimmer, comprising:
a non-circular cross section and made of degradable material.

2. The string as claimed in claim 1, wherein the degradable material is Polylactide (PLA).

3. The string as claimed in claim 1, wherein the degradable material is Polycaprolactone (PCL).

4. The string as claimed in claim 1, wherein the degradable material is Polyvinyl Acetate (PVA).

5. The string as claimed in claim 1, wherein the string has a rectangular cross section.

6. The string as claimed in claim 1, wherein the string has a hexagonal cross section.

7. The string as claimed in claim 1, wherein the string has a star-shaped cross section.

8. The string as claimed in claim 1, wherein the string is a spiral string with multiple cutting edges spirally extending along a longitudinal axis of the string.
